(19) United States
(12) Patent Application Publication
(10) Pub. No.: US 2017/0137946 A1
(43) Pub. Date: May 18, 2017

(54) CLEAR-COATED STAINLESS STEEL SHEET

(71) Applicant: NIPPON STEEL & SUMIKIN STAINLESS STEEL CORPORATION, Tokyo (JP)

(72) Inventors: Haruki ARIYOSHI, Tokyo (JP); Youichirou YASUDA, Amagasaki-shi (JP)

(73) Assignee: NIPPON STEEL & SUMIKIN STAINLESS STEEL CORPORATION, Tokyo (JP)

(21) Appl. No.: 15/127,453

(22) PCT Filed: Apr. 7, 2015
(86) PCT No.: PCT/JP2015/060857

§ 371 Date: Sep. 20, 2016

(30) Foreign Application Priority Data
Apr. 9, 2014 (JP) 2014-080375

(51) Int. Cl. C23C 30/00; B05D 1/28; B05D 1/04; B05D 1/02; B05D 1/30

(52) U.S. Cl. CPC C23C 30/00; B05D 1/02; B05D 1/305; B05D 1/30; B05D 1/04; B05D 1/28

(57) ABSTRACT

This clear-coated stainless steel sheet includes: a stainless steel sheet; a clear resin layer formed on the stainless steel sheet; and resin beads (D) included in the clear resin layer, wherein the clear resin layer includes: a lowermost layer including a first thermosetting resin composition (A) containing an acryl resin (a1) having a crosslinking functional group; and an uppermost layer including a second thermosetting resin composition (B), and an average particle diameter of the resin beads (D) is 0.7 times to 1.5 times the film thickness of the clear resin layer.

### TECHNICAL FIELD

The present invention relates to a clear-coated stainless steel sheet.

The present application claims priority on Japanese Patent Application No. 2014-080375 filed on Apr. 9, 2014, the content of which is incorporated herein by reference.

### BACKGROUND ART

Stainless steel sheets have been frequently used for chassis, interior furnishing materials, and external materials of domestic or business electronic appliances since luxury appearances can be obtained using the characteristic aesthetically pleasing metallic gloss of stainless steel.

Stainless steel sheets that are used for electronic appliances are roughly classified into stainless steel sheets used in a state of being uncoated and stainless steel sheets used in a state of being coated (used with coated surfaces). Hereinafter, stainless steel sheets having coated surfaces will be referred to as “clear-coated stainless steel sheets”. Stainless steel sheets that are used for external materials of electronic appliances are, in many cases, used with coated surfaces in order to impart design properties and enhance corrosion resistance, stain resistance, and the like.

However, clear-coated stainless steel sheets have a problem in that indentations called pressure printings (pressure marks) are caused. “Pressure printings” refer to indentations caused by the following fact: in the case where a plurality of clear-coated stainless steel sheets are stacked in a state of being laminated together or in the case where long clear-coated stainless steel sheets are stored in a coiled state, pressure is applied to coated films (clear resin layers) formed on the surfaces of the stainless steel sheets due to the weights of the clear-coated stainless steel sheets, and thus the clear resin layers collapse.

With regard to the phenomenon of pressure printings, indentations that occur are observed as gloss unevenness on the surfaces of coated films. Possible causes of the gloss unevenness that occurs are described below. Hereinafter, in the case where a plurality of clear-coated stainless steel sheets are stacked in a state of being laminated together or in the case where long clear-coated stainless steel sheets are stored in a coiled state, a clear-coated stainless steel sheet in a certain layer is called “a lower clear-coated stainless steel sheet”, and a clear-coated stainless steel sheet located on the lower clear-coated stainless steel sheet is called “an upper clear-coated stainless steel sheet”. In addition, the surface of the lower clear-coated stainless steel sheet on the clear resin layer side is called “the front surface of the clear-coated stainless steel sheet”, and the surface of the upper clear-coated stainless steel sheet on the stainless steel sheet side is called “the rear surface of the clear-coated stainless steel sheet”.

In detail, the case where a clear resin layer is provided only on one main surface among two main surfaces of a clear-coated stainless steel sheet, and a plurality of clear-coated stainless steel sheets are laminated together in a state in which the clear resin layer is located as the upper surface will be described. With regard to two arbitrary clear-coated stainless steel sheets that are laminated together in a state of being in contact with each other, the clear-coated stainless steel sheet located on the lower side is called “the lower clear-coated stainless steel sheet”, and the clear-coated stainless steel sheet located on the upper side is called “the upper clear-coated stainless steel sheet”. Among two main surfaces of the clear-coated stainless steel sheet, the surface provided with the clear resin layer is called the front surface, and the surface which is not provided with any clear resin layers and on which stainless steel is exposed is called the rear surface. The front surface of the lower clear-coated stainless steel sheet is in contact with the rear surface of the upper clear-coated stainless steel sheet.

For example, in the case where the roughness of the front surface of the clear-coated stainless steel sheet is greater than the roughness of the rear surface of the clear-coated stainless steel sheet, the unevenness of the front surface of the lower clear-coated stainless steel sheet is evened due to pressure from the rear surface side of the upper clear-coated stainless steel sheet, and thus the gloss is enhanced. At this time, it is thought that, since only the top portions of protrusion portions constituting the unevenness are evened, the enhancement of the gloss fluctuates, and consequently, the gloss becomes uneven.

On the other hand, in the case where the roughness of the front surface of the clear-coated stainless steel sheet is less than the roughness of the rear surface of the clear-coated stainless steel sheet, unevenness of the rear surface is transferred to the front surface of the lower clear-coated stainless steel sheet due to pressure from the rear surface side of the upper clear-coated stainless steel sheet, and thus the gloss deteriorates. At this time, it is thought that, since the protrusion portions constituting the unevenness are more strongly transferred, the deterioration of the gloss fluctuates, and consequently, the gloss becomes uneven.

As described above, indentations called pressure printings are observed as partial or total deterioration of the gloss on the front surfaces of clear-coated stainless steel sheets or the enhancement of gloss. When pressure printings occur, these changes in gloss fluctuate, and thus the design properties of clear-coated stainless steel sheets deteriorate, and commodity values are impaired.

As countermeasures for pressure printings, methods for decreasing pressure by reducing the weights of coils obtained by coiling clear-coated stainless steel sheets or by limiting the number of clear-coated stainless steel sheets being laminated are commonly known.

However, in these methods, the productivity of clear-coated stainless steel sheets is greatly degraded, and it is also necessary to broaden storage spaces to store clear-coated stainless steel sheets, and thus it is difficult to apply these methods in practice to ordinary mass-produced products, particularly, inexpensive products.

Therefore, studies are underway regarding methods for reducing occurrences of pressure printings without limiting the weights of coils or the number of sheets being laminated.

For example, methods are known in which the rear surfaces of stainless steel sheets are also coated, and occurrences of pressure printings are reduced using a cushioning effect of coated films (clear resin layers) on the rear surface side.

However, in these methods, effects to a certain degree could be expected; however, it was not possible to obtain sufficient effects only by, simply, coating the rear surfaces of the stainless steel sheets.

Therefore, methods have been proposed in which occurrences of pressure printings are reduced by approximating the gloss values or the surface roughnesses between a coated film (clear resin layer) on the front surface side and a coated film (clear resin layer) on the rear surface side of a steel sheet (for example, refer to Patent Document 1).

In addition, methods have been proposed in which the difference in hardness is decreased by decreasing the difference in the glass transition temperature between a coated film (clear resin layer) on the front surface side and a coated film (clear resin layer) on the rear surface side of a steel sheet; and thereby, occurrences of pressure printings are reduced (for example, refer to Patent Document 2).

However, in the case of the methods described in Patent Documents 1 and 2, it is necessary to coat the rear surfaces of steel sheets at all times, and the methods are not suitable for manufacturing clear-coated stainless steel sheets in which rear surfaces are uncoated.

In addition, in the case of the methods described in Patent Document 1, the gloss values or the front surface roughnesses are close between the front surface and the rear surface of the clear-coated stainless steel sheet, and thus there are cases in which design properties are limited.

In the case of the methods described in Patent Document 2, the glass transition temperature also has an influence on coating performance other than surface hardness, such as processability or water resistance. Therefore, there are cases in which the kinds of a paint are limited in order to decrease the difference in the glass transition temperature while also taking the influence on processability or water resistance into account.

Therefore, as clear-coated stainless steel sheets having excellent anti-pressure printing property even when the rear surfaces of the stainless steel sheets are not coated, clear-coated stainless steel sheets obtained by blending resin beads into clear resin layers have been proposed (for example, refer to Patent Document 3).

However, in recent years, for clear-coated stainless steel sheets, there has been a demand for excellent anti-pressure printing property at a higher level.

### PRIOR ART DOCUMENTS

### Patent Documents

Patent Document 1: Japanese Unexamined Patent Application, First Publication No. 2003-200528
Patent Document 2: Japanese Patent No. 3157105
Patent Document 3: Japanese Unexamined Patent Application, First Publication No. 2011-224975

### DISCLOSURE OF THE INVENTION

### Problems to be Solved by the Invention

An object of the present invention is to provide a clear-coated stainless steel sheet having excellent anti-pressure printing property.

### Means for Solving the Problem

The present invention has the following aspects.

[1] A clear-coated stainless steel sheet, including: a stainless steel sheet; a clear resin layer formed on the stainless steel sheet; and resin beads (D) included in the clear resin layer, in which the clear resin layer includes: a lowermost layer including a first thermosetting resin composition (A) containing an acryl resin (a1) having a crosslinking functional group; and an uppermost layer including a second thermosetting resin composition (B), and an average particle diameter of the resin beads (D) is 0.7 times to 1.5 times a film thickness of the clear resin layer.

[2] The clear-coated stainless steel sheet according to [1], in which the clear resin layer includes the resin beads (D) at an amount of 0.2 parts by mass to 5.0 parts by mass with respect to 100 parts by mass of the first thermosetting resin composition (A).

[3] The clear-coated stainless steel sheet according to [1] or [2], in which the resin beads (D) are included at least in the lowermost layer.

### Effects of the Invention

According to the present invention, it is possible to provide a clear-coated stainless steel sheet having excellent anti-pressure printing property.

### BRIEF DESCRIPTION OF THE DRAWINGS

FIG. 1 is a sectional view schematically showing an embodiment example of a clear-coated stainless steel sheet of the present invention.

### EMBODIMENTS FOR CARRYING OUT THE INVENTION

Hereinafter, the present invention will be described in detail.

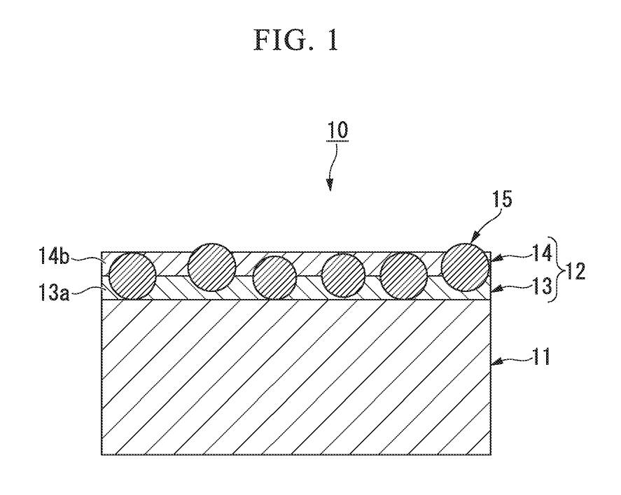

FIG. 1 is a sectional view schematically showing an embodiment example of a clear-coated stainless steel sheet of the present invention. A clear-coated stainless steel sheet 10 of the present embodiment example includes: a stainless steel sheet 11; a clear resin layer 12 formed on the stainless steel sheet 11; and resin beads (D) 15 included in the clear resin layer 12. In the present embodiment, the clear resin layer 12 is provided only on one main surface among two main surfaces of the stainless steel sheet 11. Hereinafter, the main surface of the stainless steel sheet 11 provided with the clear resin layer 12 will also be referred to as the front surface.

In FIG. 1, for convenience of description, the dimensional ratios are different from the actual dimensional ratios.

(Stainless Steel Sheet)

A well-known stainless steel sheet is used as the stainless steel sheet 11.

On the front surface (the surface in contact with the clear resin layer 12) of the stainless steel sheet 11, a chemical conversion coating film (not illustrated) may be formed by carrying out chemical conversion coating thereon from the viewpoint of improving the adhesiveness to the clear resin layer 12.

(Clear Resin Layer)

The clear resin layer 12 in the present embodiment example has a bilayer structure consisting of a lowermost layer 13 and an uppermost layer 14. In addition, the clear resin layer 12 contains the resin beads (D) 15.

In the present embodiment, “being clear” means that the light transmittance in the visible light range is 30% or higher. The light transmittance in the visible light range refers to a light transmittance measured in a wavelength range of 380 nm to 750 nm using a spectrophotometer.

In the case where the light transmittance of the clear resin layer 12 in the visible light range is lower than 30%, although visible light slightly passes through the clear resin layer, the stainless steel sheet 11 is barely visible. Therefore, it is not possible to obtain designs taking advantages of the aesthetically pleasing appearance of stainless steel.

The visible light transmittance of the clear resin layer 12 is preferably 40% or higher and more preferably 50% or higher.

<Lowermost Layer>

The lowermost layer 13 is a layer in contact with the stainless steel sheet 11 and includes a first thermosetting resin composition (A) 13a containing an acryl resin (a1) having a crosslinking functional group.

(First Thermosetting Resin Composition (Thermosetting Resin Composition (A)))

The thermosetting resin composition (A) 13a contains an acryl resin (a1) having a crosslinking functional group.

The acryl resin (a1) having a crosslinking functional group has excellent adhesiveness to the stainless steel sheet 11; and therefore, in the case where the lowermost layer 13 includes the thermosetting resin composition (A) 13a, the stainless steel sheet 11 and the lowermost layer 13 favorably adhere to each other.

Examples of the crosslinking functional group include hydroxy groups, carboxy groups, alkoxysilane groups, and the like.

The acryl resin (a1) can be obtained by reacting a non-functional monomer and a polymerizable monomer having the crosslinking functional group.

Examples of the non-functional monomer include aliphatic or cyclic acrylates such as methyl acrylate, ethyl acrylate, isopropyl acrylate, n-butyl acrylate, 2-ethylhexyl acrylate, methyl methacrylate, ethyl methacrylate, isopropyl methacrylate, n-butyl methacrylate, n-hexyl methacrylate, cyclohexyl acrylate, cyclohexyl methacrylate, and lauryl methacrylate; vinyl ethers such as methyl vinyl ether, ethyl vinyl ether, n-propyl vinyl ether, and n-butyl vinyl ether; styrenes such as styrene and α-methyl styrene; acrylamides such as acrylamide, N-methylol acrylamide, and diacetone acrylamide, and the like.

One kind of these non-functional monomers may be solely used, or two or more kinds thereof may be used together.

Examples of the polymerizable monomer having the crosslinking functional group include hydroxy group-containing polymerizable monomers, carboxy group-containing polymerizable monomers, alkoxysilane group-containing polymerizable monomers, and the like.

Hydroxy group-containing polymerizable monomers refer to monomers having one or more hydroxy groups and one or more polymerizable unsaturated double bonds respectively. Specific examples of the above-described monomers include hydroxylalkyl esters such as 2-hydroxyethyl acrylate, 2-hydroxyethyl methacrylate, hydroxypropyl acrylate, and hydroxypropyl methacrylate; lactone-modified hydroxyl group-containing vinyl polymerized monomers (for example, PLACCEL FM1, 2, 3, 4, 5, FA-1, 2, 3, 4, and 5 (all manufactured by Daicel Corporation) and the like).

Carboxy group-containing polymerizable monomers refer to monomers having one or more carboxy groups and one or more polymerizable unsaturated double bonds respectively. Specific examples of the above-described monomers include acrylic acids, methacrylic acids, itaconic acids, maleic acids, fumaric acids, and the like.

Alkoxysilane group-containing polymer monomers refer to monomers having one or more alkoxysilane groups and one or more polymerizable unsaturated double bonds respectively. Specific examples of the above-described monomers include vinyl-trimethoxy-silane, vinyl-triethoxy-silane, methacryloxy-propyl-trimethoxy-silane, and the like.

One kind of these polymerizable monomers having the crosslinking functional group may be solely used, or two or more kinds thereof may be used together.

The thermosetting resin composition (A) 13a preferably further includes an isocyanate resin (a2).

The isocyanate resin (a2) refers to a crosslinking resin that cures the acryl resin (a1). Mixtures including the acryl resin (a1) and a resin that cures the acryl resin (a1) are also referred to as thermosetting acryl resin compositions.

In the case where the thermosetting resin composition (A) 13a includes the isocyanate resin (a2), the acryl resin (a1) has a crosslinking structure, the strength of the lowermost layer 13 increases, and the adhesiveness of the lowermost layer 13 to the stainless steel sheet 11 is further improved.

As the isocyanate resin (a2), there are non-block-type isocyanate resins of which curing reactions proceed even at normal temperature and block-type isocyanate resins. With regard to the block-type isocyanate resins, in the case where isocyanate groups are blocked using blocking agents such as phenols, oximes, active methylenes, ε-caprolactams, triazoles, pyrazoles, and the like, reactions do not proceed at normal temperature; however, curing reactions proceed when the block-type isocyanate resins are heated.

As the isocyanate resin (a2), any of the non-block-type isocyanate resin and the block-type isocyanate resin can be used; however, in the case where clear-coated stainless steel sheets are produced by precoating-type coating, block-type isocyanate resins are preferable since block-type isocyanate resins is excellent in the workability during continuous production.

The block-type isocyanate resin (a2) is a compound having two or more isocyanate groups in the molecule. Specific examples of the above-described compound include aromatic diisocyanates such as tolylene diisocyanates, diphenyl-methane diisocyanates, xylene diisocyanates, and naphthalene diisocyanates; aliphatic diisocyanates such as hexamethylene diisocyanates and dimer acid diisocyanates; alicyclic diisocyanates such as isophorone diisocyanates and cyclohexane diisocyanates; Biuret-type adducts or isocyanurate ring-type adducts of these isocyanates, and the like.

The ratio of the crosslinking functional groups (for example, OH groups, COOH groups, or the like) in the acryl resin (a1) to the isocyanate groups (NCO groups) in the isocyanate resin (a2) (the equivalent ratio of the crosslinking functional groups/the NCO groups) is preferably in a range of 1.0/0.2 to 1.0/2.0, more preferably in a range of 1.0/0.2 to 1.0/1.5, and still more preferably in a range of 1.0/0.5 to 1.0/1.2. In the case where the equivalent ratio is 1.0/0.2 or higher, the crosslinking of the thermosetting resin composition (A) becomes sufficient, and thus the adhesiveness of the lowermost layer 13 to the stainless steel sheet 11 is improved, and water resistance or chemical resistance also becomes favorable. In the case where the equivalent ratio is 1.0/2.0 or lower, the amount of the isocyanate groups becomes appropriate, and thus unreacted isocyanate resin (a2) rarely remains, and the curing property of the thermosetting resin composition (A) can be favorably maintained. When the curing property of the thermosetting resin composition (A) is favorable, degradation of the hardness of the thermosetting resin composition (A) can be prevented, and thus it is possible to further reduce occurrences of indentations due to pressure applied to the clear resin layer.

In the case where the thermosetting resin composition (A) 13a contains the isocyanate resin (a2), the thermosetting resin composition (A) 13a may further include a curing catalyst for accelerating crosslinking reactions between the acryl resin (a1) and the isocyanate resin (a2). Particularly, in the case where a block-type isocyanate resin is used as the isocyanate resin (a2), the curing catalyst serves as a disassociation accelerator of blocking agents, and thus the thermosetting resin composition (A) 13a preferably contains a curing catalyst.

The curing catalyst is preferably an organic tin catalyst, and specific examples thereof include di-n-butyltin oxide, n-dibutyltin chloride, di-n-butyltin dilaurate, di-n-butyltin diacetate, di-n-octyltin oxide, di-n-octyltin dilaurate, tetra-n-butyltin, and the like.

One kind of these curing catalysts may be solely used, or two or more kinds thereof may be used together.

The amount of the curing catalyst is preferably in a range of 0.005 parts by mass to 0.08 parts by mass and more preferably in a range of 0.01 parts by mass to 0.06 parts by mass with respect to 100 parts by mass of the total of the solid amounts of the acryl resin (a1) and the isocyanate resin (a2). In the case where the amount of the curing catalyst is 0.005 parts by mass or more, the effects of the curing catalyst can be sufficiently obtained. In the case where the amount of the curing catalyst exceeds 0.08 parts by mass, not only are the effects of the curing catalyst saturated, but also there are cases in which the isocyanate groups (NCO groups) react with moisture and the like in the air due to the reactivity becoming excessively strong and thus, conversely, the 1:1 reactions with the crosslinking functional groups (for example, OH groups, COOH groups, and the like) in the acryl resin (a1) are inhibited. As a result, there is a concern that weather resistance degrades and thus the intrinsic performance is reduced. In addition, in the case where a non-block-type isocyanate resin is used as the isocyanate resin (a2), the reactivity of a paint becomes extremely fast, and thus it becomes necessary to conduct coating immediately after mixing the acrylate resin (a1) and the isocyanate resin (a2), and the coating workability greatly degrades.

(Other Components)

The lowermost layer 13 may further include additives, and examples of the additives include: light resistance-imparting agents such as ultraviolet absorbents and light stabilizers; organic pigments and inorganic pigments having transparency; brightening materials such as a variety of pearlescent pigments and aluminum pastes; dispersants; defoamers; levelling agents; rheology-controlling agents; wetting agents; lubricants; and the like.

(Film Thickness)

The film thickness of the lowermost layer 13 is preferably in a range of 2 μm to 15 μm and more preferably in a range of 3 μm to 10 μm. In the case where the film thickness of the lowermost layer 13 is 2 μm or greater, stable production becomes easy. In addition, wear resistance also becomes excellent. In the case where the film thickness of the lowermost layer 13 is 15 μm or smaller, transparency can be favorably maintained, and thus design properties are superior.

<Uppermost Layer>

The uppermost layer 14 is a layer located in the top portion of the clear resin layer 12 and includes the thermosetting resin composition (B) 14b.

(Second thermosetting resin composition (thermosetting resin composition (B))) Resins that are included in the thermosetting resin composition (B) 14b are not particularly limited and are determined depending on functions required for the uppermost layer 14, and examples thereof include thermosetting resins such as acryl resins, polyester resins, alkid resins, epoxy resins, fluororesins, silicone resins, and acrylsilicone resins. For example, acryl resins are preferable in order to impart high hardness and transparency to the uppermost layer 14, and polyester resins are preferable in order to impart processability.

Examples of the acryl resins include the examples of the acryl resin (a1) having the crosslinking functional groups which are previously explained in the description of the lowermost layer 13.

Examples of the polyester resins include resins having crosslinking functional groups such as hydroxy groups, carboxy groups, and the like, and the polyester resins can be obtained by reacting polyhydric alcohols and polybasic carboxylic acids.

Examples of the polyhydric alcohols include ethylene glycol, diethylene glycol, polyethylene glycol, propylene glycol, dipropylene glycol, polypropylene glycol, neopentyl glycol, 1,2-butanediol, 1,4-butanediol, 1,8-butanediol, 2,3-butanediol, 1,5-pentanediol, 1,6-hexanediol, 1,4-cyclohexanedimethanol, 2,3-dimethyl-3-hydroxypropyl-2,2-dimethyl-3-hydroxypropionate, N,N-bis-(2-hydroxyethyl)dimethylhydantoin, poly ethophmethylene ether glycol, polycaprolactone polyol, glycerin, sorbitol, annitol, trimethylolethane, trimethylolpropane, trimethylolbutane, hexanetriol, pentaerythritol, dipentaerythritol, tris-(hydroxyethyl)isocyanate, and the like.

Examples of the polybasic carboxylic acids include phthalic acid, phthalic anhydride, tetrahydrophthalic acid, tetrahydrophthalic anhydride, hexahydrophthalic acid, hexahydrophthalic anhydride, tetrahydrophthalic acid, methyl tetrahydrophthalic acid, methyl tetrahydrophthalic anhydride, himic anhydride, trimellitic acid, trimellitic anhydride, pyromellitic acid, pyromellitic anhydride, isophthalic acid, terephthalic acid, maleic acid, maleic anhydride, fumaric acid, itaconic acid, adipic acid, azelaic acid, sebacic acid, succinic acid, succinic anhydride, lactic acid, dodecenylsuccinic acid, dodecenylsuccinic anhydride, cyclohexane-1,4-dicarboxylic acid, endo anhydride, and the like.

With regard to each of polyhydric alcohol and polybasic carboxylic acid, one kind selected from the examples may be solely used, or two or more kinds selected from the examples may be used together.

The thermosetting resin composition (B) 14b preferably further includes crosslinking resins that cure the thermosetting resins included in the thermosetting resin composition (B) 14b. In the case where the thermosetting resin composition (B) 14b contain crosslinking resins, the thermosetting resins have a crosslinking structure, the strength of the uppermost layer 14 increases, and the adhesiveness of the uppermost layer 14 to the lowermost layer 13 is improved.

The crosslinking resins are determined depending on the kinds of the thermosetting resins included in the thermosetting resin composition (B) 14b. For example, in the case where the thermosetting resin composition (B) 14b contains an acryl resin as the thermosetting resin, the crosslinking resin is preferably an isocyanate resin.

Examples of the isocyanate resin include the examples of the isocyanate resin (a2) which are previously explained in the description of the lowermost layer 13.

The ratio of crosslinking functional groups (for example, OH groups, COOH groups, or the like) in an acryl resin included in the thermosetting resin composition (B) 14b to isocyanate groups (NCO groups) in an isocyanate resin (the equivalent ratio of the crosslinking functional groups/the NCO groups) is preferably in a range of 1.0/0.2 to 1.0/2.0, more preferably in a range of 1.0/0.2 to 1.0/1.5, and still more preferably in a range of 1.0/0.5 to 1.0/1.2. In the case where the equivalent ratio is 1.0/0.2 or higher, the crosslinking of the thermosetting resin composition (B) becomes sufficient, and thus the adhesiveness of the uppermost layer 14 to the lowermost layer 13 is improved, and water resistance or chemical resistance also becomes favorable. In the case where the equivalent ratio is 1.0/2.0 or lower, the amount of the isocyanate groups becomes appropriate, and thus unreacted isocyanate resin rarely remains, and the curing property of the thermosetting resin composition (B) can be favorably maintained. When the curing property of the thermosetting resin composition (B) is favorable, degradation of the hardness of the thermosetting resin composition (B) can be prevented, and thus it is possible to further reduce the occurrences of indentations due to pressure applied to the clear resin layer.

In addition, in the case where the thermosetting resin composition (B) 14b contains a polyester resin as the thermosetting resin, the crosslinking resin is preferably an amino resin or an isocyanate resin.

Examples of the isocyanate resin include the examples of the isocyanate resin (a2) which are previously explained in the description of the lowermost layer 13.

The amino resin is a collective term for resins obtained by causing an addition reaction of an amino compound (for example, melamine, guanamine, urea, or the like) and formaldehyde (formalin) and modifying the resulting product using an alcohol, and specific examples thereof include melamine resins, benzoguanamine resins, urea resins, butylated urea resins, butylated urea melamine resins, glycoluril resins, acetoguanamine resins, cyclohexyl guanamine resins, and the like. Among them, melamine resins are preferable in terms of reaction rates and processability.

In addition, melamine resins are divided into methylated melamine resins, n-butylated melamine resins, isobutylated melamine resins, mixed alkylated melamine resins, and the like depending on the kind of the alcohol being modified. Among them, methylated melamine resins are particularly preferable since the reactivity is excellent and the balance with flexibility is excellent.

The ratio of crosslinking functional groups in the polyester resin included in the thermosetting resin composition (B) 14b to isocyanate groups (NCO groups) in the isocyanate resin (the equivalent ratio of the crosslinking functional groups/the NCO groups) is preferably in a range of 1.0/0.2 to 1.0/2.0, more preferably in a range of 1.0/0.2 to 1.0/1.5, and still more preferably in a range of 1.0/0.5 to 1.0/1.2. In the case where the equivalent ratio is 1.0/0.2 or higher, the crosslinking of the thermosetting resin composition (B) becomes sufficient, and thus the adhesiveness of the uppermost layer 14 to the lowermost layer 13 is improved, and water resistance or chemical resistance also becomes favorable. In the case where the equivalent ratio is 1.0/2.0 or lower, the amount of the isocyanate groups becomes appropriate, and thus unreacted isocyanate resin rarely remains, and the curing property of the thermosetting resin composition (B) can be favorably maintained. When the curing property of the thermosetting resin composition (B) is favorable, degradation of the hardness of the thermosetting resin composition (B) can be prevented, and thus it is possible to further reduce the occurrences of indentations due to pressure applied to the clear resin layer.

The amount of the amino resin is preferably in a range of 15 parts by mass to 50 parts by mass and more preferably in a range of 25 parts by mass to 40 parts by mass with respect to 100 parts by mass of the total of the solid amount of the polyester resin included in the thermosetting resin composition (B) 14b. In the case where the amount of the amino resin is 15 parts by mass or more, the crosslinking density of the uppermost layer 14 increases, and thus the adhesiveness to the lowermost layer 13 is further improved. In addition, the surface hardness of the uppermost layer 14 becomes sufficient, and thus scratch resistance is enhanced. In the case where the amount of the amino resin is 50 parts by mass or less, the flexibility of the uppermost layer 14 is enhanced. Therefore, in the case where the uppermost layer 14 contains resin beads (D) 15 described below, it becomes easy to hold the resin beads (D) 15. In addition, cracking due to processing can be prevented.

In the case where the thermosetting resin composition (13) 14b contains the crosslinking resin, the thermosetting resin composition (B) 14b may further include a curing catalyst for accelerating crosslinking reactions between the thermosetting resin and the crosslinking resin.

The curing catalyst is determined depending on the kinds of the thermosetting resins and the crosslinking resin which are included in the thermosetting resin composition (B) 14b. For example, in the case where the thermosetting resin composition (B) 14b contains an acryl resin and an isocyanate resin, the curing catalyst is preferably an organic tin catalyst.

Examples of the organic tin catalyst include the examples of the organic tin catalyst which are previously explained in the description of the lowermost layer 13.

The amount of the curing catalyst is preferably in a range of 0.005 parts by mass to 0.08 parts by mass and more preferably in a range of 0.01 parts by mass to 0.06 parts by mass with respect to 100 parts by mass of the total of the solid amounts of the acryl resin and the isocyanate resin. In the case where the amount of the curing catalyst is 0.005 parts by mass or more, the effects of the curing catalyst can be sufficiently obtained. In the case where the amount of the curing catalyst exceeds 0.08 parts by mass, not only are the effects of the curing catalyst saturated, but also there are cases in which the isocyanate groups (NCO groups) react with moisture and the like in the air due to the reactivity becoming excessively strong and thus, conversely, the 1:1 reactions with the crosslinking functional groups (for example, OH groups, COOH groups, and the like) in the acryl resin are inhibited. As a result, there is a concern that weather resistance degrades and thus the intrinsic performance cannot be exhibited. In addition, in the case where a non-block-type isocyanate resin is used as the isocyanate resin, the reactivity of a paint becomes extremely fast, and thus it becomes necessary to conduct coating immediately after mixing the acrylate resin and the isocyanate resin, and the coating workability greatly degrades.

In addition, in the case where the thermosetting resin composition (B) 14b contains a polyester resin and an amino resin, the curing catalyst is preferably a sulfonic acid-based or amine-based curing catalyst. Particularly, for the purpose of further enhancing the surface hardness of the uppermost layer 14, p-toluene sulfonic acid or dodecyl benzene sulfonic acid which is a sulfonic acid-based curing catalyst having higher reactivity is preferably used.

In addition, although described below in detail, in the formation of the uppermost layer 14 and the like, a paint including the thermosetting resin composition (B) 14b and the like is prepared, and the uppermost layer 14 is formed using this paint. From the viewpoint of improving the storage stability of a paint, it is also possible to use block-type acid catalysts as the curing catalyst, and in the block-type acid catalysts, reactive groups are sealed with amine and the like and thus reactions at normal temperature are prevented. Examples of these block-type acid catalysts include amine block-type of the above-described sulfonic acid-based curing catalysts and the like.

The amount of the curing catalyst is preferably in a range of 0.1 parts by mass to 4.0 parts by mass with respect to 100 parts by mass of the total of the solid amounts of the polyester resin and the amino resin. In the case where the amount of the curing catalyst is 0.1 parts by mass or more, the effects of the curing catalyst can be sufficiently obtained. In the case where the amount of the curing catalyst exceeds 4.0 parts by mass, not only are the effects of the curing catalyst saturated, but also there are cases in which the storage stability of a paint degrades.

In the case where the thermosetting resin composition (B) 14b contains a polyester resin and an isocyanate resin, the curing catalyst is preferably an organic tin catalyst, similar to the curing catalyst in the case where the thermosetting resin composition contains an acryl resin and an isocyanate resin.

Examples of the organic tin catalyst include the examples of the organic tin catalyst which are previously explained in the description of the lowermost layer 13 and the like.

The amount of the curing catalyst is equal to the amount of the curing catalyst in the case where the thermosetting resin composition contains an acryl resin and an isocyanate resin.

(Other Components)

The uppermost layer 14 may further include additives, and examples of the additives include: light resistance-imparting agents such as ultraviolet absorbents and light stabilizers; organic pigments and inorganic pigments having transparency; brightening materials such as a variety of pearlescent pigments and aluminum pastes; dispersants; defoamers; levelling agents; rheology-controlling agents; wetting agents; lubricants; and the like.

(Film Thickness)

The film thickness of the uppermost layer 14 is preferably in a range of 3 μm to 30 μm and more preferably in a range of 10 μm to 20 μm. In the case where the film thickness of the uppermost layer 14 is 3 μm or greater, it is possible to stably form the clear resin layer 12 during production, and a variety of performances required for the uppermost layer 14 can be sufficiently exhibited. In the case where the film thickness of the uppermost layer 14 is 30 μm or smaller, transparency can be favorably maintained, and thus design properties are superior.

<Resin Beads (D)>

The resin beads (D) 15 are a component for imparting anti-pressure printing property to the clear resin layer 12.

When a plurality of the clear-coated stainless steel sheets 10 are laminated together or a long clear-coated stainless steel sheet 10 is stored in a coiled state (hereinafter, in some cases, also referred to as “during the storage of the clear-coated stainless steel sheets”), the occurrences of pressure printings can be reduced by decreasing the contact area between the clear resin layer 12 in the lower clear-coated stainless steel sheet 10 and the stainless steel sheet 11 in the upper clear-coated stainless steel sheet 10. In order to decrease this contact area, it is necessary to increase the roughness of the surface of the clear resin layer 12, and the clear resin layer 12 containing the resin beads (D) 15 enables an increase of the roughness of the surface of the clear resin layer 12.

Resin as a material of the resin beads (D) 15 is not particularly limited, and examples thereof include an acryl resin, a urethane resin, a benzoguanamine resin, a styrene resin, a polyethylene resin, a polypropylene resin, an epoxy resin, and the like. Among them, acryl resin-based beads (acryl resin beads) are preferable since the beads themselves have high hardness, also have transparency, and, furthermore, have excellent compatibility with the above-described acryl resin (a1).

The resin beads (D) 15 are classified into crosslinking resin beads and non-crosslinking resin beads depending on the kinds of resins being used.

As the resin beads (D) 15, any one of crosslinking resin beads and non-crosslinking resin beads can be used. While described below in detail, the resin beads (D) 15 are used in a state of being blended into a paint that is used to form the clear resin layer 12. In the case where this paint is a solvent type paint, the resin beads (D) 15 need to have solvent resistance. Crosslinking resin beads maintain their shape and continuously maintain shapes or elasticity necessary to impart anti-pressure printing property even in the case where crosslinking resin beads are added to a paint and then are stored for a long period of time. On the other hand, non-crosslinking resin beads have poorer solvent resistance than that of crosslinking resin beads. Therefore, although it is possible to maintain shapes or elasticity necessary to impart anti-pressure printing property in the initial state after non-crosslinking resin beads are added to a paint, but the non-crosslinking resin beads tend to gradually swell or dissolve as time elapses, and there are cases in which the intrinsic functions are impaired.

Therefore, the resin beads (D) 15 are preferably crosslinking resin beads.

Examples of commercially available products of crosslinking acryl resin beads include ART PEARL A-400, G-200, G-400, G-600, G-800, GR-200, GR-300, GR-400, GR-600, GR-800, J-4P, J-5P, J-7P, and S-5P (all manufactured by Negami Chemical Industrial Co., Ltd.); TECHPOLYMER MBX-8, MBX-12, MBX-15, MBX-30, MBX-40, MBX-50, MB20X-5, MB20X-30, MB30X-5, MB30X-8, MB30X-20, BM30X-5, BM30X-8, BM30X-12, ARX-15, ARX-30, MBP-8, and ACP-8 (all manufactured by Sekisui Plastics Co., Ltd.); CHEMISNOW MX-150, MX-180TA, MX-300, MX-500, MX-500H, MX-1000, MX-1500H, MX-2000, MX-3000, MR-2HG, MR-7HG, MR-10HG, MR-3GSN, MR-2G, MR-7G, MR-10G, MR-200, MR-30G, MR-60G, MR-90G, MZ-JOHN, MZ-12H, MZ-16H, and MZ-20HN (manufactured by Soken Chemical & Engineering Co., Ltd.); STAPHYLOID AC-3355, AC-3816, AC-3832, AC-4030, AC-3364, GM-0401S, GM-0801, GM-1001, GM-2001, GM-2801, GM-4003, GM-5003, GM-9005, and GM-6292 (all manufactured by Ganz Chemical Co., Ltd.) and the like.

Examples of commercially available products of crosslinking urethane resin beads include ART PEARL C-100, C-200, C-300, C-400, C-800, CZ-400, P-400T, P-800T, HT-400BK, U-600T, CF-600T, MT-400BR, and MT-400YO (all manufactured by Negami Chemical Industrial Co., Ltd.), and the like.

One kind of the resin beads (D) 15 may be solely used, or two or more kinds thereof may be used together.

The average particle diameter of the resin beads (D) 15 is 0.7 times to 1.5 times, preferably 0.8 times to 1.2 times, and more preferably 0.9 times to 1.1 times the film thickness of the clear resin layer 12. In the case where the average particle diameter of the resin beads (D) is within the above-describe range, it becomes easy for some of the resin beads (D) 15 to be exposed on the surface (the surface on the uppermost layer 14 side) of the clear resin layer 12, and it is possible to decrease the contact area between the clear resin layer 12 of the lower clear-coated stainless steel sheet 10 and the stainless steel sheet 11 of the upper clear-coated stainless steel sheet 10 during the storage of the clear-coated stainless steel sheets 10. Furthermore, the exposed resin beads (D) 15 play a role of supporting (propping) sheets between the lower clear-coated stainless steel sheet 10 and the upper clear-coated stainless steel sheet 10. As a result, even when pressure is applied to the clear resin layer 12 of the lower clear-coated stainless steel sheet 10, the clear resin layer 12 can be prevented from being deformed because the resin beads (D) 15 serve as supports (props). That is, indentations do not easily remain in the clear resin layer 12, and anti-pressure printing property is improved. In the case where the average particle diameter of the resin beads (D) 15 is 0.7 times or more the film thickness of the clear resin layer 12, it becomes easy for some of the resin beads (D) 15 to be exposed on the surface of the clear resin layer 12, and the above-described contact area can be decreased. Particularly, in the case where the average particle diameter of the resin beads (D) 15 is 0.9 times or more the film thickness of the clear resin layer 12, the resin beads (D) 15 are prevented from being sunk due to pressure applied to the clear resin layer 12. Therefore, the resin beads (D) are capable of sufficiently exhibiting a role as a support, the deformation of the clear resin layer 12 is further prevented, and anti-pressure printing property is further improved. In the case where the average particle diameter of the resin beads (D) 15 is 1.5 times or less the film thickness of the clear resin layer 12, it is possible to prevent the resin beads (D) 15 from being excessively exposed on the surface of the clear resin layer 12, and the unevenness on the surface of the clear resin layer 12 is reduced. In addition, the appearance of the clear resin layer 12 can also be favorably maintained.

The average particle diameter of the resin beads (D) 15 is a value measured by a laser diffraction scattering method.

As long as the resin beads (D) 15 maintain the average particle diameter in the above-described range and are present in the clear resin layer 12, the resin beads may be included in any of the lowermost layer 13 or the uppermost layer 14. As described above, the resin beads (D) 15 decrease the above-described contact area during the storage of the clear-coated stainless steel sheets 10. In addition, the resin beads (D) also play a role of preventing the clear resin layer 12 from being deformed when pressure is applied to the clear resin layer 12. In order to sufficiently exert the effect of preventing the deformation of the clear resin layer 12 (deformation-preventing effect) and further improve anti-pressure printing property, it is preferable that the resin beads (D) 15 are included at least in the lowermost layer 13 and it is more preferable that the resin beads (D) 15 are included in both of the lowermost layer 13 and the uppermost layer 14. In such a case, the resin beads (D) 15 are prevented from being sunk due to pressure applied to the clear resin layer 12, and the resin beads (D) are capable of sufficiently exhibiting a role as a support. In addition, in order to further enhance the deformation-preventing effect, at least some of the resin beads (D) 15 included in the lowermost layer 13 are preferably in contact with the stainless steel sheet 11.

In the case where at least some of the resin beads (D) 15 are in contact with the stainless steel sheet 11, the stainless steel sheet 11 serves as a support, and it is possible to effectively prevent the resin beads (D) 15 from being sunk due to pressure applied to the clear resin layer 12. As a result, the deformation-preventing effect is further enhanced, and anti-pressure printing property is further improved.

In the case where the resin beads (D) 15 are included in both of the lowermost layer 13 and the uppermost layer 14, the same resin beads (D) 15 may be shared in the lowermost layer 13 and the uppermost layer 14, or the average particle diameter of the resin beads (D) 15 may vary from layer to layer (the average particle diameter of the resin beads (D) 15 included in one layer may be different from that included in the other layer). In order to share the same resin beads (D) 15 in the lowermost layer 13 and the uppermost layer 14, although described in detail below, the lowermost layer 13 having a film thickness smaller than the average particle diameter of the resin beads (D) 15 may be formed using a paint containing the resin beads (D) 15 and then the uppermost layer 14 may be formed on the lowermost layer 13. According to this method, it is possible to save efforts for blending the resin beads (D) 15 into a paint for forming the uppermost layer 14 and also it is possible to reduce manufacturing costs. Furthermore, it becomes easy for the resin beads (D) 15 to come into contact with the stainless steel sheet 11.

In addition, in the case where the average particle diameter of the resin beads (D) 15 varies from layer to layer, the average particle diameter of the resin beads (D) 15 included at least in any one layer needs to be 0.7 times to 1.5 times the film thickness of the clear resin layer 12. Particularly, the average particle diameter of the resin beads (D) 15 included in the lowermost layer 13 is preferably 0.7 times to 1.5 times the film thickness of the clear resin layer 12. In this case, the average particle diameter of the resin beads (D) 15 included in the uppermost layer 14 is preferably 1.5 times or less and more preferably 1.0 times or less the film thickness of the uppermost layer 14 from the viewpoint of reducing unevenness on the surface of the clear resin layer 12.

The amount of the resin beads (D) 15 in the clear resin layer 12 is preferably in a range of 0.2 parts by mass to 5.0 parts by mass and more preferably in a range of 0.5 parts by mass to 3.0 parts by mass with respect to 100 parts by mass of the total of the solid amount of the thermosetting resin composition (A) 13b. In the case where the amount of the resin beads (D) 15 is 0.2 parts by mass or more, anti-pressure printing property is improved. In the case where the amount of the resin beads (D) 15 is 5.0 parts by mass or less, it is possible to prevent degradation of the transparency of the clear resin layer 12 or degradation of the gloss of the clear-coated stainless steel sheet 10 and it is possible to favorably maintain design properties. In addition, it is possible to prevent degradation of the flexibility of the clear resin layer 12 and it is possible to favorably maintain the processability of the clear-coated stainless steel sheet 10.

<Method for Manufacturing Clear-Coated Stainless Steel Sheets>

The clear-coated stainless steel sheet 10 of the present embodiment can be obtained by forming the lowermost layer 13 on the stainless steel sheet 11 and then forming the uppermost layer 14 on the lowermost layer 13 (a step of forming a clear resin layer).

Before the lowermost layer 13 is formed on the stainless steel sheet 11, as described above, chemical conversion coating is preferably carried out on the stainless steel sheet 11 (step of forming a chemical conversion coating film).

(Step of Forming Chemical Conversion Coating Film)

The step of forming a chemical conversion coating film is a step in which a chemical conversion coating fluid is coated on at least one surface (the surface on which the lowermost layer 13 is to be formed) of the stainless steel sheet 11 and is dried; and thereby, a chemical conversion coating film is formed.

As the chemical conversion coating fluid, there are chromate chemical conversion coating fluids and non-chromate chemical conversion coating fluids, and non-chromate chemical conversion coating fluids are preferable when environmental issues are taken into account.

Non-chromate chemical conversion coating fluids include coupling agents, solvating media such as water or solvents, and crosslinking agents or liquid antirust agents according to necessity.

As the coupling agent that is used in the chemical conversion coating fluid, non-chromate coupling agents are preferable when environmental issues are taken into account, and specific examples thereof include aminosilane-based coupling agents such as N-2(aminoethyl)-3-aminopropyl-methyl-dimethoxy-silane, N-2(aminoethyl)-3-aminopropyl-triethoxy-silane, 3-amino-propyl-trimethoxy-silane, and 3-amino-propyl-triethoxy-silane; epoxysilane-based coupling agents such as 2-(3,4-epoxy-cyclohexyl)ethyl trimethoxy-silane, 3-glycidoxy-propyl-trimethoxy-silane, and 3-glycidoxy-propyl-methyl-diethoxy-silane, and the like.

One kind of these coupling agents may be solely used, or two or more kinds thereof may be used solely.

Solvents that are used in the chemical conversion coating fluid are not particularly limited, and examples thereof include hydrocarbons such as toluene, xylene, benzene, cyclohexane, and hexane; alcohols such as methanol, ethanol, propanol, and butanol; ester compounds such as ethyl acetate and butyl acetate; ether compounds such as diethyl ether; ketones such as acetone, methyl ethyl ketone, and methyl isobutyl ketone; polar solvents such as dimethyl formamide and dimethyl sulfoixde; and the like.

One kind of these solvents may be solely used, or two or more kinds thereof may be used together.

The chemical conversion coating is carried out by coating the chemical conversion coating fluid on the surface of the stainless steel sheet 11 and drying the chemical conversion coating fluid so that the attached amount of the chemical conversion coating fluid becomes 2 mg/m² to 50 mg/m² (the amount of SiO₂ is measured using fluorescent X-rays).

As a method for coating the chemical conversion coating fluid, methods such as spraying, roll coating, bar coating, curtain flow coating, and electrostatic coating can be used.

During the drying of the chemical conversion fluid, the solvent in the chemical conversion fluid coated on the stainless steel sheet 11 needs to be evaporated, and, as the drying temperature, the peak metal temperature (PMT) of the stainless steel sheet 11 is appropriately 60° C. to 140° C.

During the chemical conversion coating, a well-known prior treatment such as alkali degreasing or etching using an acid or an alkali, and the like may be carried out on the front surface of the stainless steel sheet 11 according to necessity.

(Step of Forming Clear Resin Layer)

The step of forming a clear resin layer includes: a step of forming a lowermost layer step; and a step of forming an uppermost layer.

The step of forming a lowermost layer is a step in which a paint for forming the lowermost layer (hereinafter, also referred to as “the paint (A)”) is coated on the chemical conversion coating film formed on the stainless steel sheet 11 or on the surface of the stainless steel sheet 11 and is cured; and thereby, the lowermost layer 13 is formed.

The paint (A) includes the thermosetting resin composition (A), a solvent, and additives such as light resistance-imparting agents and the like according to necessity. In addition, in order to form the lowermost layer 13 including the resin beads (D) 15, the resin beads (D) 15 are blended into the paint (A).

Examples of solvents that are used in the paint (A) include the examples of the solvents which are previously explained in the description of the chemical conversion coating fluid.

Examples of a method for coating the paint (A) include the same method as the method for coating the chemical conversion coating fluid.

As curing conditions after the paint (A) is coated, the stainless steel sheet is preferably heated so that the peak metal temperature (PMT) of the stainless steel sheet 11 becomes 200° C. to 270° C., and the peak metal temperature (PMT) is more preferably 210° C. to 250° C. In the case where the peak metal temperature (PMT) is lower than 200° C., curing reactions do not sufficiently proceed, and not only the surface hardness of the lowermost layer 13 may decrease but also adhesiveness between the stainless steel sheet 11 and the lowermost layer 13 may degrade. On the other hand, in the case where the peak metal temperature exceeds 270° C., it becomes easy for the flexibility of the lowermost layer 13 to degrade. In addition, the clear-coated stainless steel sheet 10 may become yellowish and thus design properties may be degraded.

The step of forming an uppermost layer is a step in which a paint for forming the uppermost layer (hereinafter, also referred to as “the paint (B)”) is coated on the lowermost layer 13 and is cured; and thereby, the uppermost layer 14 is formed.

The paint (B) includes the thermosetting resin composition (B), a solvent, and additives such as light resistance-imparting agents and the like according to necessity. In addition, in order to form the uppermost layer 14 including the resin beads (D) 15, the resin beads (D) 15 are blended into the paint (B). However, in the case where the lowermost layer 13 is formed so that the film thickness becomes thinner than the average particle diameter of the resin beads (D) 15 during the formation of the lowermost layer 13 including the resin beads (D) 15, the resin beads (D) 15 become exposed on the surface of the lowermost layer 13. Since the uppermost layer 14 is formed by coating the paint (B) on the lowermost layer 13 on which the resin beads (D) 15 are exposed, the uppermost layer 14 including the resin beads (D) 15 can be obtained without blending the resin beads (D) 15 into the paint (B). In this case, the same resin beads (D) 15 are shared by the lowermost layer 13 and the uppermost layer 14.

Examples of solvents that are used in the paint (B) include the examples of the solvents which are previously explained in the description of the chemical conversion coating fluid.

A method for coating the paint (B) and curing conditions after the paint (B) is coated are the same as those of the paint (A).

<Actions and Effects>

According to the clear-coated stainless steel sheet of the present embodiment which has thus far been described, the clear resin layer has a multilayer structure, and the lowermost layer in the clear resin layer includes the above-described thermosetting resin composition (A). Therefore, the clear resin layer has excellent adhesiveness to the stainless steel sheet. In addition, since the clear resin layer includes the resin beads (D) having a specific average particle diameter, the clear resin layer has excellent anti-pressure printing property. The reasons for the excellent anti-pressure printing property are considered to be as follows.

Since the clear resin layer includes the resin beads (D) having a specific average particle diameter, it becomes easy for some of the resin beads (D) to be exposed on the surface of the clear resin layer (the surface on the uppermost layer side) as described above. As a result, during the storage of the clear-coated stainless steel sheets, the contact area between the clear resin layer 12 in the lower clear-coated stainless steel sheet 10 and the stainless steel sheet 11 in the upper clear-coated stainless steel sheet 10 decreases. In addition, even when pressure is applied to the clear resin layer 12, the resin beads (D) 15 serve as supports, and it is possible to prevent the clear resin layer 12 from being deformed. That is, indentations do not easily remain in the clear resin layer 12. Therefore, it is considered that anti-pressure printing property is improved.

Particularly, the resin beads (D) need to be included at least in the lowermost layer. In addition, more preferably, the resin beads (D) need to be included in both of the lowermost layer and the uppermost layer. In this case, it is possible to prevent the resin beads (D) from being sunken due to pressure applied to the clear resin layer and it is also possible to further prevent the clear resin layer from being deformed even when pressure is applied to the clear resin layer, and anti-pressure printing property is further improved. Furthermore, when at least some of the resin beads (D) are in contact with the stainless steel sheet, the stainless steel sheet serves as a support, and it is possible to further prevent the resin beads (D) from being sunken. As a result, the deformation-preventing effect of the clear resin layer is further enhanced, and anti-pressure printing property is further improved.

In addition, since the clear resin layer in the clear-coated stainless steel sheet of the present embodiment has a multilayer structure, it is also possible to easily impart functions other than anti-pressure printing property depending on the use of the clear-coated stainless steel sheet. For example, in the case where light resistance-imparting agents are added to the uppermost layer, it is possible to obtain clear-coated stainless steel sheets also having excellent light resistance.

In recent years, there have been many cases in which home electronics and the like are required to have higher functionality, and, similarly, clear-coated stainless steel sheets have been required to have high functionality such as having a plurality of functions. The clear-coated stainless steel sheet of the present embodiment is capable of imparting different functions (for example, anti-pressure printing property, light resistance, and the like), and thus it is possible to provide products of high value.

<Use Applications>

The clear-coated stainless steel sheet of the present embodiment is suitably used as chassis, interior furnishing materials, and external materials of domestic or business electronic appliances and electronic device products.

### Other Embodiments

The clear-coated stainless steel sheet of the present invention is not limited to the above-described clear-coated stainless steel sheet. The clear-coated stainless steel sheet 10 shown in FIG. 1 includes the clear resin layer 12 having a bilayer structure but may include three or more clear resin layers in which one or more other layers (intermediate layers) are laminated between the lowermost layer 13 and the uppermost layer 14.

In addition, in the clear-coated stainless steel sheet 10 shown in FIG. 1, the clear resin layer 12 is formed on one surface of the stainless steel sheet 11, but the clear resin layer may also be formed on the other surface of the stainless steel sheet 11. Hereinafter, the clear resin layer 12 formed on one surface of the stainless steel sheet 11 will be referred to as “the first clear resin layer”, and the clear resin layer formed on the other surface of the stainless steel sheet 11 will be referred to as “the second clear resin layer”. In addition, the surface of the stainless steel sheet on which the first clear resin layer is formed will be referred to as “the front surface of the stainless steel sheet”, and the surface of the stainless steel sheet on which the second clear resin layer is formed will be referred to as “the rear surface of the stainless steel sheet”.

As described above, pressure printings occur due to pressure applied during coiling and the like of steel sheets; however, in the case where the clear-coated stainless steel sheet further includes the second clear resin layer, it is possible to more effectively improve pressure printings. The reasons therefor are considered to be as follows.

In the case where the second clear resin layer is not formed on the rear surface of the stainless steel sheet, during the storage of the clear-coated stainless steel sheets, the first clear resin layer in the lower clear-coated stainless steel sheet comes into direct contact with the stainless steel sheet in the upper clear-coated stainless steel sheet. On the other hand, in the case where the second clear resin layer is formed on the rear surface of the stainless steel sheet, the first clear resin layer in the lower clear-coated stainless steel sheet comes into contact with the second clear resin layer in the upper clear-coated stainless steel sheet. The second clear resin layer is softer than the stainless steel sheet, and the difference in hardness between the first clear resin layer in the lower clear-coated stainless steel sheet and the second clear resin layer in the upper clear-coated stainless steel sheet decreases. Therefore, it is possible to mitigate pressure applied to the first clear resin layer in the lower clear-coated stainless steel sheet; and thereby, the occurrences of pressure printings can be further reduced.

The second clear resin layer may have a monolayer structure or a multilayer structure. Here, the second clear resin layer having a monolayer structure will be described.

The second clear resin layer is a layer including a thermosetting resin composition (F). Resins included in the thermosetting resin composition (F) are not particularly limited as long as the resins have adhesiveness to a stainless steel sheet, and examples thereof include thermosetting resins such as acryl resins, polyester resins, alkid resins, epoxy resins, fluororesins, silicone resins, acrylsilicone resins, and the like. In addition, the thermosetting resin composition (F) may also include crosslinking resins that cure the thermosetting resins. Examples of the crosslinking resins include the examples of the crosslinking resins which are previously explained in the description of the uppermost layer 14.

The second clear resin layer preferably includes the resin beads (D). In the case where the second clear resin layer includes the resin beads (D), anti-pressure printing property is further improved.

The average particle diameter of the resin beads (D) included in the second clear resin layer is preferably 0.7 times to 5.0 times and more preferably 1.0 time to 3.0 times the film thickness of the second clear resin layer. In the case where the average particle diameter of the resin beads (D) is 0.7 times or more the film thickness of the second clear resin layer, it becomes easy for some of the resin beads (D) to be exposed on the surface of the second clear resin layer. Therefore, it is possible to decrease the contact area between the first clear resin layer in the lower clear-coated stainless steel sheet and the second clear resin layer in the upper clear-coated stainless steel sheet during the storage of the clear-coated stainless steel sheets. On the other hand, in the case where the average particle diameter of the resin beads (D) is 5.0 times or less the film thickness of the second clear resin layer, it is possible to prevent the resin beads (D) from being excessively exposed on the surface of the second clear resin layer. Therefore, during the storage of the clear-coated stainless steel sheets, uneven indentations rarely remain on the first clear resin layer in the lower clear-coated stainless steel sheet due to the resin beads (D) included in the second clear resin layer in the upper clear-coated stainless steel sheet.

Examples of the resin beads (D) included in the second clear resin layer include the examples of the resin beads (D) which are previously explained in the description of the first clear resin layer.

The film thickness of the second clear resin layer is not particularly limited but is preferably 20 μm or smaller in the case where design properties are also required in the second clear resin layer.

### EXAMPLES

Hereinafter, the present invention will be specifically described using examples, but the present invention is not limited to the examples.

(Preparation of Thermosetting Resin Composition (A))

<Preparation of Thermosetting Resin Composition (A-1)>

Toluene (25 parts by mass) and butyl acetate (24 parts by mass) were fed into a four-neck flask including a thermometer, a reflux condenser, a stirrer, a dropping funnel, and a nitrogen gas introduction tube, the mixture was heated up to 110° C., and was stirred while nitrogen gas was blown in. A mixture of raw materials which consisted of methyl methacrylate (16 parts by mass), styrene (5 parts by mass), n-butyl methacrylate (19.5 parts by mass), 2-hydroxyethyl methacrylate (9 parts by mass), methyl acrylate (0.5 parts by mass), azobisisobutyronitrile (AIBN) (1 part by mass) was added dropwise (added by drops) for three hours. After completion of the dropwise addition, AIBN was further added, and, furthermore, a reaction proceeded at the same temperature for three hours. Thereby, an acryl-based copolymer (acryl resin (a1-1)) having 50% by mass of a non-volatile component was obtained. This acryl resin (a1-1) (100 parts by mass) was dissolved in xylene (60 parts by mass); and thereby, an acryl resin solution (a1-2) was obtained.

The obtained acryl resin solution (a1-2) and a block-type isocyanate resin solution (manufactured by Sumika Bayer Urethane Co., Ltd., “DESMODUR VPLS2253”, the amount of an NCO group was 10.5%) as an isocyanate resin solution (a2) were mixed together so that the ratio (the equivalent ratio of OH groups/NCO groups) of hydroxy groups (OH groups) in the acryl resin solution (a1-2) to isocyanate groups (NCO groups) in the isocyanate resin solution (a2) was 1/1; and thereby, a thermosetting resin composition (A-1) was obtained.

(Preparation of Thermosetting Resin Compositions (B))

<Preparation of thermosetting resin composition (B-1)>

A polyester resin solution (manufactured by Mitsui Chemicals, Inc., “ARMATEX P-646”) (100 parts by mass) and a methylated melamine resin solution (manufactured by Mitsui Cytec Ltd., “CYMEL 303”) (15 parts by mass) were mixed together; and thereby, a thermosetting resin composition (B-1) was obtained.

<Preparation of Thermosetting Resin Composition (B-2)>

An acryl resin solution (a1-2) obtained in the same manner as in the preparation of the thermosetting resin composition (A-1) and a block-type isocyanate resin solution (manufactured by Sumika Bayer Urethane Co., Ltd., “DESMODUR VPLS2253”, the amount of an NCO group was 10.5%) as an isocyanate resin solution were mixed together so that the ratio (the equivalent ratio of OH groups/NCO groups) of hydroxy groups (OH groups) in the acryl resin solution (a1-2) to isocyanate groups (NCO groups) in the isocyanate resin solution was 1/1; and thereby, a thermosetting resin composition (B-2) was obtained.

<Preparation of Thermosetting Resin Composition (B-3)>

A polyester resin solution (manufactured by Nippon Polyurethane Industry Co., Ltd “NIPPOLLAN 121E”) and a block-type isocyanate resin solution (manufactured by Sumika Bayer Urethane Co., Ltd., “DESMODUR VPLS2253”, the amount of an NCO group was 10.5%) as an isocyanate resin solution were mixed together so that the ratio (the equivalent ratio of crosslinking functional groups/NCO groups) of the total of crosslinking functional groups (OH groups and COOH groups) in the polyester resin solution to isocyanate groups (NCO groups) in the isocyanate resin solution was 1/1; and thereby, a thermosetting resin composition (B-3) was obtained.

(Preparation of Thermosetting Resin Compositions (F))

<Preparation of Thermosetting Resin Composition (F-1)>

A bisphenol A-type epoxy resin solution (manufactured by Mitsui Chemicals, Inc., “EPOKEY 803”) as an epoxy resin (100 parts by mass) and a methylated melamine resin solution (manufactured by Mitsui Cytec Ltd., “CYMEL 703”) (20 parts by mass) were mixed together; and thereby, a thermosetting resin composition (F-1) was obtained.

(Resin Beads (D))

As the resin beads (D), compounds described below were used.
D-1: Crosslinking acryl resin beads (manufactured by Sekisui Plastics Co., Ltd., “TECHPOLYMER MSX-15”, the average particle diameter was 15 μm)
D-2: Crosslinking acryl resin beads (manufactured by Soken Chemical & Engineering Co., Ltd., “CHEMISNOW MX-2000”, an average particle diameter was 20 μm)
D-3: Crosslinking acryl resin beads (manufactured by Negami Chemical Industrial Co., Ltd., “ART PEARL GR-200 Transparent”, the average particle diameter was 25 μm)
D-4: Crosslinking acryl resin beads (manufactured by Nippon Shokubai Co., Ltd., “ART EPOSTAR MA1010”, the average particle diameter was 10 μm)
D-5: Crosslinking acryl resin beads (manufactured by Soken Chemical & Engineering Co., Ltd., “CHEMISNOW MX-500”, the average particle diameter was 5 μm)
D-6: Crosslinking acryl resin beads (manufactured by Sekisui Plastics Co., Ltd., “TECHPOLYMER BX-30”, the average particle diameter was 30 μm)
D-7: Crosslinking acryl resin beads (manufactured by Ganz Chemical Co., Ltd., “GANZPEARL GM-5003”, the average particle diameter was 50 μm)
D-8: Crosslinking acryl resin beads (manufactured by Soken Chemical & Engineering Co., Ltd., “CHEMISNOW MR-2G”, the average particle diameter was 1 μm)
D-9: Non-crosslinking acryl resin beads (manufactured by Matsumoto Yushi-Seiyaku Co., Ltd., “MATSUMOTO MICROSPHERE M-100”, the average particle diameter of 20 μm)
D-10: Crosslinking urethane resin beads (manufactured by Negami Chemical Industrial Co., Ltd., “ART PEARL C300 Transparent”, the average particle diameter was 20 μm)
D-11: Non-crosslinking urethane resin beads (manufactured by DIC Corporation, “BURNOCK CFB620-40”, the average particle diameter was 20 μm)

### Example 1

<Preparation of Paint>

The thermosetting resin composition (A-1) (100 parts by mass in terms of the solid amount) and the resin beads (D-1) (1 part by mass in terms of the solid amount) were mixed together; and thereby, a paint for forming lowermost layers (paint (A)) was prepared.

Separately, the thermosetting resin composition (B-1) was used as a paint for forming uppermost layers (paint (B)).

<Manufacturing of Clear-Coated Stainless Steel Sheets>

(Step of Forming Chemical Conversion Coating Film)

An SUS430/No. 4 polishing finish material was used as a stainless steel sheet.

A non-chromate chemical conversion coating fluid was coated on this stainless steel sheet by a roll coater so that the amount of SiO₂ was 2 mg/m² to 10 mg/m². The amount of SiO₂ on the stainless steel sheet was measured using fluorescent X-rays. In addition, the stainless steel sheet was dried so that the peak metal temperature (PMT) was 100° C.; and thereby, a chemical conversion coating film was formed.

(Step of Forming Clear Resin Layer)

The paint (A) was coated on the chemical conversion coating film on the stainless steel sheet by a bar coater so that the film thickness after drying was 10 μm. The stainless steel sheet was dried so that the peak metal temperature (PMT) was 210° C.; and thereby, a lowermost layer was formed.

Next, the paint (B) was coated on the lowermost layer by a bar coater so that the film thickness after drying was 10 μm. The stainless steel sheet was dried so that the peak metal temperature was 232° C.; and thereby, an uppermost layer was formed. As a result, a clear-coated stainless steel sheet in which a clear resin layer consisting of the lowermost layer and the uppermost layer was formed on one surface (front surface) of the stainless steel sheet was obtained.

For the obtained clear-coated stainless steel sheet, adhesiveness, processability, anti-pressure printing property, temporal stability of the resin beads, and appearance were evaluated on the basis of the following evaluation methods. The results are shown in Table 1.

<Measurements and Evaluations>

(1) Evaluation of Adhesiveness

The adhesiveness of the clear resin layer to the stainless steel sheet was evaluated according to JIS K5600-5-6/Adhesion (cross-cut test).

5: Peeling was not observed even at the intersections of cuts.

4: Extremely slight peeling was observed at the intersections or edges of cuts.

3: Almost 20% of cells were peeled from the intersections or edges of cuts.

2: The layer greatly cracked along the edges of cuts and almost 50% of cells were peeled.

1: The cut portions were fully peeled.

(2) Evaluation of Processability

As test subjects, rectangular clear-coated stainless steel sheets were prepared. One side of the clear-coated stainless steel sheet from the center thereof in the longitudinal direction was sandwiched by two sheets having the same thickness as the clear-coated stainless steel sheet. Next, the clear-coated stainless steel sheet was bent 180 degrees along the center in the longitudinal direction as a bending portion, the bent clear-coated stainless steel sheet and the two sheets were superimposed together and were tightly fastened using a vice.

The degree of cracking at the processed places stretched (bent) in the above-described manner was enlarged and visually observed using a magnifier of 30 times power; and thereby, processability was evaluated using the following evaluation standards.

5: Cracks were not observed in the processed places.

4: Several fine cracks were observed in the processed places.

3: A number of small cracks could be visually confirmed in the processed places.

2: Large cracks could also be confirmed together with small cracks in the processed places.

1: A number of large cracks occurred in the processed places, and the coated film was turned outward.

(3) Evaluation of Anti-Pressure Printing Property

The clear-coated stainless steel sheet was coiled around a stainless steel coil having a weight of 2 t and was left to stand for one week. The clear-coated stainless steel sheet that had been left to stand was visually observed, and the anti-pressure printing property was evaluated using the following evaluation standards.

5: The occurrences of pressure printings were not observed.

4: A small number of pressure printings could be confirmed but disappeared within one day.

3: A small number of pressure printings could be confirmed and did not disappeared.

2: Deep pressure printings could be confirmed.

1: Extreme pressure printings occurred, and blocking also occurred.

(4) Evaluation of Temporal Stability of Resin Beads

The temporal stability of the resin beads was evaluated using the following method. A paint was prepared by adding the resin beads to the thermosetting resin composition and then, immediately after the preparation, the paint was cured and dried; and thereby, a coated film (coated film α) was produced. In addition, a paint was prepared by adding the resin beads to the thermosetting resin composition and then, after a certain period of time, the paint was cured and dried; and thereby, a coated film (coated film β) was produced. For the coated film α and the coated film β, the anti-pressure printing property was evaluated respectively in the same manner as in the above-described section (3). It was confirmed whether or not the anti-pressure printing property degraded more in the coated film β than in the coated film α, and the temporal stability of the resin beads was evaluated using the following evaluation standards.

5: The anti-pressure printing property remained unchanged even in coated films produced by adding the resin beads to the thermosetting resin composition and then, after one or more months, curing and drying a paint.

4: It was confirmed that the anti-pressure printing property slightly degraded in coated films produced by adding the resin beads to the thermosetting resin composition and then, after one or more months, curing and drying a paint.

3: The anti-pressure printing property degraded in coated films produced by adding the resin beads to the thermosetting resin composition and then, after two weeks or more and shorter than one month, curing and drying a paint.

2: The anti-pressure printing property degraded in coated films produced by adding the resin beads to the thermosetting resin composition and then, after one weeks or more and shorter than two weeks, curing and drying a paint.

1: The anti-pressure printing property degraded in coated films produced by adding the resin beads to the thermosetting resin composition and then, after shorter than one week, curing and drying a paint.

(5) Evaluation of Appearance

(5-1) Uneven Feelings of Clear Resin Layer

Uneven feelings on the surface (the surface on the uppermost layer side) of the clear resin layer were visually observed, and the uneven feelings were evaluated using the following standards.

5: There were no uneven feelings.

4: There were slight uneven feelings which could be observed at close distances.

3: There were slight uneven feelings, and the uneven feelings could also be slightly recognized by a tactual sense.

2: There were clear uneven feelings, and the uneven feelings could also surely recognized by a tactual sense.

1: There was no gloss.

(5-2) White Turbidity of Clear Resin Layer

The appearance of the clear resin layer was visually observed, and the appearance was evaluated using the following evaluation method.

5: There was no white turbidity of the clear resin layer regardless of illuminance conditions.

4: The white turbidity of the clear resin layer could be confirmed only when observed at an illuminance of higher than 1,500 lx.

3: The white turbidity of the clear resin layer could be confirmed at an illuminance of 300 lx to 1,500 lx.

2: The white turbidity of the clear resin layer could be confirmed at an illuminance of lower than 300 lx.

1: The extremely strong white turbidity of the clear resin layer could be confirmed regardless of illuminance conditions.

### Examples 2 to 10 and 13 to 28, and Comparative Examples 1 to 5, 7, 8, 10, 11, and 13

A clear-coated stainless steel sheet was manufactured in the same manner as in Example 1 except that a paint (A) and a paint (B) were prepared and the obtained paint (A) and the obtained paint (B) were used so as to obtain the lowermost layer and the uppermost layer having the features shown in Tables 1 to 5, and a variety of measurements and evaluations were carried out. The results are shown in Table 1 to 5.

In Examples 7 and 8, the temporal stability of the resin beads was evaluated for the paint (A). In Example 28 and Comparative Example 13, the temporal stability of the resin beads was evaluated for the paint (B).

### Example 11 and Comparative Examples 6, 9, and 12

A clear resin layer (first clear resin layer) consisting of a lowermost layer and an uppermost layer was formed on one surface (front surface) of a stainless steel sheet in the same manner as in Example 1 except that a paint (A) and a paint (B) were prepared and the obtained paint (A) and the obtained paint (B) were used so as to obtain the lowermost layer and the uppermost layer having the features shown in Tables 2, 4, and 5.

Next, the thermosetting resin composition (F-1) was coated on the rear surface of the stainless steel sheet by a bar coater so that the film thickness after drying was 5 μm. The stainless steel sheet was dried so that the peak metal temperature was 232° C.; and thereby, second clear resin layer was formed. Thereby, a clear-coated stainless steel sheet having the clear resin layers formed on both surfaces of the stainless steel sheet were obtained.

For the obtained clear-coated stainless steel sheets, a variety of measurement and evaluations were carried out in the same manner as in Example 1. The results are shown in Tables 2, 4, and 5.

### Example 12

A clear-coated stainless steel sheet having clear resin layers formed on both surfaces of a stainless steel sheet was obtained in the same manner as in Example 11 except that a mixture of the thermosetting resin composition (F-1) (100 parts by mass in terms of the solid amount) and the resin beads (D-5) (1 part by mass in terms of the solid amount) was coated on the rear surface of the stainless steel sheet.

For the obtained clear-coated stainless steel sheet, a variety of measurement and evaluations were carried out in the same manner as in Example 1. The results are shown in Table 2. In Example 12, the temporal stability of the resin beads was evaluated for the paint (A).

TABLE 1

| | | | | Example | | | | | | | | | |
|---|---|---|---|---|---|---|---|---|---|---|---|---|---|
| | | | | 1 | 2 | 3 | 4 | 5 | 6 | 7 | 8 | 9 | 10 |
| Front | Lowermost | Thermosetting | Kind | A-1 | A-1 | A-1 | A-1 | A-1 | A-1 | A-1 | A-1 | A-1 | A-1 |
| surface | layer | resin composition | Amount [parts by mass] | 100 | 100 | 100 | 100 | 100 | 100 | 100 | 100 | 100 | 100 |
| | | (A) | | | | | | | | | | | |
| | | Resin beads (D) | Kind | D-1 | D-2 | D-3 | D-4 | D-2 | D-2 | D-2 | D-2 | D-2 | D-2 |
| | | | Amount [parts by mass] | 1 | 1 | 1 | 1 | 1 | 1 | 3 | 1 | 0.5 | 3 |
| | | Film thickness [μm] | | 10 | 10 | 10 | 5 | 15 | 5 | 10 | 10 | 10 | 10 |
| | Uppermost | Thermosetting | Kind | B-1 | B-1 | B-1 | B-1 | B-1 | B-1 | B-1 | B-1 | B-1 | B-1 |
| | layer | resin composition | Amount [parts by mass] | 100 | 100 | 100 | 100 | 100 | 100 | 100 | 100 | 100 | 100 |
| | | (B) | | | | | | | | | | | |
| | | Resin beads (D) | Kind | — | — | — | — | — | — | D-4 | D-2 | — | — |
| | | | Amount [parts by mass] | — | — | — | — | — | — | 1 | 1 | — | — |

| | | | | | | | | | | |
|---|---|---|---|---|---|---|---|---|---|---|
| Film thickness [μm] | 10 | 10 | 10 | 5 | 5 | 15 | 10 | 10 | 10 | 10 |

| | | | | | | | | | | | | |
|---|---|---|---|---|---|---|---|---|---|---|---|---|
| Rear | Thermosetting resin | Kind | — | — | — | — | — | — | — | — | — | — |
| surface | composition (F) | Amount [parts by mass] | — | — | — | — | — | — | — | — | — | — |
| | Resin beads (D) | Kind | — | — | — | — | — | — | — | — | — | — |
| | | Amount [parts by mass] | — | — | — | — | — | — | — | — | — | — |

| | Film thickness [μm] | | — | — | — | — | — | — | — | — | — | — |
|---|---|---|---|---|---|---|---|---|---|---|---|---|
| Average particle diameter [times] of resin beads (D) | | | 0.75 | 1 | 1.25 | 1 | 1 | 1 | 1/0.5 | 1/1 | 1 | 1 |
| Evaluation | Adhesiveness | | 5 | 5 | 5 | 5 | 5 | 5 | 5 | 5 | 5 | 5 |
| | Processability | | 5 | 5 | 5 | 5 | 5 | 5 | 3 | 2 | 5 | 4 |
| | Anti-pressure printing property | | 4 | 5 | 5 | 5 | 5 | 5 | 5 | 5 | 4 | 5 |
| | Temporal stability of resin beads | | 5 | 5 | 5 | 5 | 5 | 5 | 5 | 5 | 5 | 5 |
| | Appearance | Uneven feeling | 5 | 5 | 4 | 5 | 4 | 5 | 3 | 1 | 5 | 5 |
| | | Sense of becoming whitish | 5 | 5 | 5 | 5 | 5 | 5 | 2 | 1 | 5 | 4 |

TABLE 2

| | | | | Example | | | | | | | | | |
|---|---|---|---|---|---|---|---|---|---|---|---|---|---|
| | | | | 11 | 12 | 13 | 14 | 15 | 16 | 17 | 18 | 19 | 20 |
| Front | Lowermost | Thermosetting | Kind | A-1 | A-1 | A-1 | A-1 | A-1 | A-1 | A-1 | A-1 | A-1 | A-1 |
| surface | layer | resin composition | Amount [parts by mass] | 100 | 100 | 100 | 100 | 100 | 100 | 100 | 100 | 100 | 100 |
| | | (A) | | | | | | | | | | | |
| | | Resin beads (D) | Kind | D-2 | D-2 | D-2 | D-6 | D-10 | D-9 | D-11 | D-1 | D-2 | D-3 |
| | | | Amount [parts by mass] | 1 | 1 | 6 | 1 | 1 | 1 | 1 | 1 | 1 | 1 |
| | | Film thickness [μm] | | 10 | 10 | 10 | 10 | 10 | 10 | 10 | 10 | 10 | 10 |
| | Uppermost | Thermosetting | Kind | B-1 | B-1 | B-1 | B-1 | B-1 | B-1 | B-1 | B-2 | B-2 | B-2 |
| | layer | resin composition | Amount [parts by mass] | 100 | 100 | 100 | 100 | 100 | 100 | 100 | 100 | 100 | 100 |
| | | (B) | | | | | | | | | | | |
| | | Resin beads (D) | Kind | — | — | — | — | — | — | — | — | — | — |
| | | | Amount [parts by mass] | — | — | — | — | — | — | — | — | — | — |

| | | | | | | | | | | |
|---|---|---|---|---|---|---|---|---|---|---|
| Film thickness [μm] | 10 | 10 | 10 | 10 | 10 | 10 | 10 | 10 | 10 | 10 |

| | | | | | | | | | | | | |
|---|---|---|---|---|---|---|---|---|---|---|---|---|
| Rear | Thermosetting resin | Kind | F-1 | F-1 | — | — | — | — | — | — | — | — |
| surface | composition (F) | Amount [parts by mass] | 100 | 100 | — | — | — | — | — | — | — | — |
| | Resin beads (D) | Kind | — | D-5 | — | — | — | — | — | — | — | — |
| | | Amount [parts by mass] | — | 1 | — | — | — | — | — | — | — | — |

| | Film thickness [μm] | | 5 | 5 | — | — | — | — | — | — | — | — |
|---|---|---|---|---|---|---|---|---|---|---|---|---|
| Average particle diameter [times] of resin beads (D) | | | 1 | 1 | 1 | 1.5 | 1 | 1 | 1 | 0.75 | 1 | 1.25 |
| Evaluation | Adhesiveness | | 5 | 5 | 5 | 5 | 5 | 5 | 5 | 5 | 5 | 5 |
| | Processability | | 5 | 5 | 3 | 4 | 5 | 5 | 5 | 5 | 5 | 5 |
| | Anti-pressure printing property | | 5 | 5 | 5 | 5 | 4 | 4 | 4 | 4 | 5 | 5 |
| | Temporal stability of resin beads | | 5 | 5 | 5 | 5 | 5 | 3 | 2 | 5 | 5 | 5 |
| | Appearance | Uneven feeling | 5 | 5 | 3 | 1 | 5 | 5 | 5 | 5 | 5 | 4 |
| | | Sense of becoming whitish | 5 | 5 | 1 | 4 | 5 | 5 | 5 | 5 | 5 | 5 |

TABLE 3

| | | | | Example | | | | | | | |
|---|---|---|---|---|---|---|---|---|---|---|---|
| | | | | 21 | 22 | 23 | 24 | 25 | 26 | 27 | 28 |
| Front | Lowermost | Thermosetting | Kind | A-1 | A-1 | A-1 | A-1 | A-1 | A-1 | A-1 | A-1 |
| surface | layer | resin composition | Amount [parts by mass] | 100 | 100 | 100 | 100 | 100 | 100 | 100 | 100 |
| | | (A) | | | | | | | | | |
| | | Resin beads (D) | Kind | D-2 | D-2 | D-1 | D-2 | D-3 | D-2 | D-2 | — |
| | | | Amount [parts by mass] | 0.5 | 3 | 1 | 1 | 1 | 0.5 | 3 | — |
| | | Film thickness [μm] | | 10 | 10 | 10 | 10 | 10 | 10 | 10 | 10 |
| | Uppermost | Thermosetting | Kind | B-2 | B-2 | B-3 | B-3 | B-3 | B-3 | B-3 | B-1 |
| | layer | resin composition | Amount [parts by mass] | 100 | 100 | 100 | 100 | 100 | 100 | 100 | 100 |
| | | (B) | | | | | | | | | |
| | | Resin beads (D) | Kind | — | — | — | — | — | — | — | D-2 |
| | | | Amount [parts by mass] | — | — | — | — | — | — | — | 1 |

| | | | | | | | | |
|---|---|---|---|---|---|---|---|---|
| Film thickness [μm] | 10 | 10 | 10 | 10 | 10 | 10 | 10 | 10 |

| | | | | | | | | | | |
|---|---|---|---|---|---|---|---|---|---|---|
| Rear | Thermosetting resin | Kind | — | — | — | — | — | — | — | — |
| surface | composition (F) | Amount [parts by mass] | — | — | — | — | — | — | — | — |
| | Resin beads (D) | Kind | — | — | — | — | — | — | — | — |
| | | Amount [parts by mass] | — | — | — | — | — | — | — | — |

| | Film thickness [μm] | | — | — | — | — | — | — | — | — |
|---|---|---|---|---|---|---|---|---|---|---|
| Average particle diameter [times] of resin beads (D) | | | 1 | 1 | 0.75 | 1 | 1.25 | 1 | 1 | 1 |
| Evaluation | Adhesiveness | | 5 | 5 | 5 | 5 | 5 | 5 | 5 | 5 |
| | Processability | | 5 | 4 | 5 | 5 | 5 | 5 | 4 | 5 |
| | Anti-pressure printing property | | 4 | 5 | 4 | 5 | 5 | 4 | 5 | 3 |
| | Temporal stability of resin beads | | 5 | 5 | 5 | 5 | 5 | 5 | 5 | 5 |
| | Appearance | Uneven feeling | 5 | 5 | 5 | 5 | 4 | 5 | 5 | 2 |
| | | Sense of becoming whitish | 5 | 4 | 5 | 5 | 5 | 5 | 4 | 5 |

TABLE 4

| | | | | Comparative Example | | | | | |
|---|---|---|---|---|---|---|---|---|---|
| | | | | 1 | 2 | 3 | 4 | 5 | 6 |
| Front | Lowermost | Thermosetting | Kind | A-1 | A-1 | A-1 | A-1 | A-1 | A-1 |
| surface | layer | resin composition | Amount [parts by mass] | 100 | 100 | 100 | 100 | 100 | 100 |
| | | (A) | | | | | | | |
| | | Resin beads (D) | Kind | D-4 | D-4 | D-7 | D-7 | D-4 | D-4 |
| | | | Amount [parts by mass] | 0.1 | 6 | 0.1 | 6 | 1 | 0.1 |
| | | Film thickness [μm] | | 10 | 10 | 10 | 10 | 10 | 10 |
| | Uppermost | Thermosetting | Kind | B-1 | B-1 | B-1 | B-1 | B-1 | B-1 |
| | layer | resin composition | Amount [parts by mass] | 100 | 100 | 100 | 100 | 100 | 100 |
| | | (B) | | | | | | | |
| | | Resin beads (D) | Kind | — | — | — | — | — | — |
| | | | Amount [parts by mass] | — | — | — | — | — | — |

| | | | | | | |
|---|---|---|---|---|---|---|
| Film thickness [μm] | 10 | 10 | 10 | 10 | 10 | 10 |

| | | | | | | | | |
|---|---|---|---|---|---|---|---|---|
| Rear | Thermosetting resin | Kind | — | — | — | — | — | F-1 |
| surface | composition (F) | Amount [parts by mass] | — | — | — | — | — | 100 |
| | Resin beads (D) | Kind | — | — | — | — | — | — |
| | | Amount [parts by mass] | — | — | — | — | — | — |

| | Film thickness [μm] | | — | — | — | — | — | 5 |
|---|---|---|---|---|---|---|---|---|
| Average particle diameter [times] of resin beads (D) | | | 0.5 | 0.5 | 2.5 | 2.5 | 0.5 | 0.5 |
| Evaluation | Adhesiveness | | 5 | 4 | 5 | 4 | 5 | 5 |
| | Processability | | 5 | 4 | 5 | 4 | 5 | 5 |
| | Anti-pressure printing property | | 1 | 1 | 1 | 2 | 1 | 2 |
| | Temporal stability of resin beads | | 5 | 5 | 5 | 5 | 5 | 5 |
| | Appearance | Uneven feeling | 5 | 5 | 3 | 1 | 5 | 5 |
| | | Sense of becoming whitish | 5 | 3 | 5 | 3 | 5 | 5 |

TABLE 5

| | | | | Comparative Example | | | | | | |
|---|---|---|---|---|---|---|---|---|---|---|
| | | | | 7 | 8 | 9 | 10 | 11 | 12 | 13 |
| Front | Lowermost | Thermosetting | Kind | A-1 | A-1 | A-1 | A-1 | A-1 | A-1 | A-1 |
| surface | layer | resin composition | Amount [parts by mass] | 100 | 100 | 100 | 100 | 100 | 100 | 100 |
| | | (A) | | | | | | | | |
| | | Resin beads (D) | Kind | D-4 | D-7 | D-4 | D-4 | D-7 | D-8 | — |
| | | | Amount [parts by mass] | 0.1 | 6 | 0.1 | 0.1 | 6 | 0.1 | — |
| | | Film thickness [μm] | | 10 | 10 | 10 | 10 | 10 | 10 | 10 |
| | Uppermost | Thermosetting | Kind | B-2 | B-2 | B-2 | B-3 | B-3 | B-3 | B-1 |
| | layer | resin composition | Amount [parts by mass] | 100 | 100 | 100 | 100 | 100 | 100 | 100 |
| | | (B) | | | | | | | | |
| | | Resin beads (D) | Kind | — | — | — | — | — | — | D-4 |
| | | | Amount [parts by mass] | — | — | — | — | — | — | 1 |

| | | | | | | | |
|---|---|---|---|---|---|---|---|
| Film thickness [μm] | 10 | 10 | 10 | 10 | 10 | 10 | 10 |

| | | | | | | | | | |
|---|---|---|---|---|---|---|---|---|---|
| Rear | Thermosetting resin | Kind | — | — | F-1 | — | — | F-1 | — |
| surface | composition (F) | Amount [parts by mass] | — | — | 100 | — | — | 100 | — |
| | Resin beads (D) | Kind | — | — | — | — | — | — | — |
| | | Amount [parts by mass] | — | — | — | — | — | — | — |

| | Film thickness [μm] | | — | — | 5 | — | — | 5 | — |
|---|---|---|---|---|---|---|---|---|---|
| Average particle diameter [times] of resin beads (D) | | | 0.5 | 0.5 | 0.5 | 0.5 | 2.5 | 0.05 | 0.5 |
| Evaluation | Adhesiveness | | 5 | 4 | 5 | 5 | 4 | 5 | 5 |
| | Processability | | 5 | 4 | 5 | 5 | 4 | 5 | 5 |
| | Anti-pressure printing property | | 2 | 2 | 2 | 1 | 2 | 2 | 2 |
| | Temporal stability of resin beads | | 5 | 5 | 5 | 5 | 5 | 5 | 5 |
| | Appearance | Uneven feeling | 5 | 1 | 5 | 5 | 1 | 5 | 5 |
| | | Sense of becoming whitish | 5 | 3 | 5 | 5 | 3 | 5 | 5 |

The amounts of the thermosetting resin compositions (A), (B), and (F) and the resin beads (D) in Table 1 to 5 are the amounts (parts by mass) of the solid amounts thereof.

In addition, “the average particle diameters [times] of the resin beads (D)” are relative ratios of the average particle diameter of the resin beads (D) to the film thickness of the clear resin layer. In the case where the resin beads (D) were included in both of the lowermost layer and the uppermost layer (Examples 7 and 8), the average particle diameters of the resin beads (D) are shown as “the average particle diameter [times] of the resin beads (D) included in the lowermost layer/the average particle diameter [times] of the resin beads (D) included in the uppermost layer. In addition, for Example 12, only the average particle diameter [times] of the resin beads (D) included in the first clear resin layer is shown.

The results in Tables 1 to 5 show that the clear-coated stainless steel sheets obtained in the respective examples were excellent in terms of anti-pressure printing property. In addition, the adhesiveness of the clear resin layers to the stainless steel sheets was also excellent. Among them, the clear-coated stainless steel sheets of Examples 1 to 27 in which the resin beads (D) were included in the lowermost layer were particularly excellent in terms of anti-pressure printing property. In addition, the crosslinking resin beads (D) were superior in terms of temporal stability to the non-crosslinking resin beads (D).

On the other hand, the clear-coated stainless steel sheets of the respective comparative examples in which the average particle diameter of the resin beads (D) was any one of 0.05 times, 0.5 times, and 2.5 times the film thickness of the clear resin layer were poor in terms of anti-pressure printing property.

### INDUSTRIAL APPLICABILITY

The clear-coated stainless steel sheet of the present embodiment is excellent in terms of anti-pressure printing property. Therefore, the clear-coated stainless steel sheet of the present embodiment can be widely applied as chassis, interior furnishing materials, and external materials of domestic or business electronic appliances having favorable design properties.

### REFERENCE SIGNS LIST

10 clear-coated stainless steel sheet
11 stainless steel sheet
12 clear resin layer
13 lowermost layer
13a thermosetting resin composition (A)
14 uppermost layer
14b thermosetting resin composition (B)
15 resin bead (D)

1. A clear-coated stainless steel sheet, comprising:
a stainless steel sheet;
a clear resin layer formed on the stainless steel sheet; and
resin beads (D) included in the clear resin layer,
wherein the clear resin layer includes: a lowermost layer including a first thermosetting resin composition (A) containing an acryl resin (a1) having a crosslinking functional group; and
an uppermost layer including a second thermosetting resin composition (B), and
an average particle diameter of the resin beads (D) is 0.7 times to 1.5 times a film thickness of the clear resin layer.

2. The clear-coated stainless steel sheet according to claim 1,
wherein the clear resin layer includes the resin beads (D) at an amount of 0.2 parts by mass to 5.0 parts by mass with respect to 100 parts by mass of the first thermosetting resin composition (A).

3. The clear-coated stainless steel sheet according to claim 1,
wherein the resin beads (D) are included at least in the lowermost layer.

4. The clear-coated stainless steel sheet according to claim 2,
wherein the resin beads (D) are included at least in the lowermost layer.
